(19) United States
(12) Patent Application Publication
(10) Pub. No.: US 2022/0325603 A1
(43) Pub. Date: Oct. 13, 2022

(54) ADJUSTABLE VALVE

(71) Applicant: HALLIBURTON ENERGY SERVICES, INC., Houston, TX (US)

(72) Inventors: Kevin Michael RENKES, Dallas, TX (US); Vince Paul ZELLER, Flower Mound, TX (US); Mitchell Andrew GREER, Flower Mound, TX (US)

(73) Assignee: HALLIBURTON ENERGY SERVICES, INC., Houston, TX (US)

(21) Appl. No.: 17/639,947

(22) PCT Filed: Oct. 9, 2019
(86) PCT No.: PCT/US2019/055315

§ 371 Date: Mar. 3, 2022

(51) Int. Cl. E21B 34/06; F16K 3/08

(52) U.S. Cl. CPC E21B 34/06; F16K 3/085; E21B 49/081

(57) ABSTRACT

A force setting apparatus comprises a valve manifold forming a plurality of ports and a rotary valve coupled to the valve manifold and rotatable on the valve manifold. The plurality of ports are in fluid communication with a plurality of pistons. The rotary valve is coupled to an air chamber that used to transfer low pressurized oil coming from the pistons and out of the ports. The valve is rotatable to uncover the plurality of ports and allow high pressurized oil to flow through a plurality of pistons and out of the plurality of ports. The valve is rotatable to cover the plurality of ports and allow low pressurized oil to flow through the valve and out of the air chamber.

### FIELD

The present disclosure relates to downhole force setting apparatus. In particular, the present disclosure relates to valves which can be adjusted to provide a plurality of forces.

### BACKGROUND

During the course of well testing operations, various downhole tools can be used, such as samplers and packers. A packer is used to provide a seal between the outside of the production tubing and the inside of the casing, liner, or wellbore wall. Packers isolate zones by packing off between the inside of the casing, or open hole, and outside the tubing. Closing off the space between the casing and tubing directs oil and gas up to the surface through the tubing. Most packers have a locking mechanism that is unlocked once downhole to activate the packer and to ensure the packer is not set or activated while it is running in and out of the wellbore. Samplers utilize a triggering mechanism to capture reservoir fluids in its chamber. The triggering mechanism can be a rupture disk initiated by a certain applied annular pressure, which causes the rupture disk to burst and allows fluid to flow through the passageway.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a wellbore environment with a downhole force setting apparatus installed within a downhole tool, according to the present disclosure;

FIG. 2A illustrates a schematic view of the downhole force setting apparatus in an exemplary configuration, according to the present disclosure;

FIG. 2B illustrates a schematic view of the downhole force setting apparatus in another exemplary configuration, according to the present disclosure;

FIG. 3A illustrates a schematic view of a sampler assembly with a downhole force setting apparatus, according to the present disclosure;

FIG. 3B illustrates an isometric schematic view of the sampler assembly of FIG. 3A, according to the present disclosure;

FIG. 4 illustrates an isometric schematic view of a packer with a downhole force setting apparatus, according to the present disclosure.

FIG. 5 illustrates a flowchart in accordance with an example embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein is a downhole force setting apparatus which may be located within the wall of a sampler assembly, packer, or other downhole tool that utilizes downhole force for activation. The downhole force setting apparatus can have multiple configurations, from generating a smaller force and gradually increasing or decreasing the force generated, as desired. The force setting device includes a valve, such as a rotary valve, which selectively covers and uncovers one or more ports to permit entry of fluid from the borehole into a settable device, such as a packer. The valve may be actuated to uncover and cover the one or more ports based on a predetermined detected downhole property, such as pressure. Upon uncovering one or more ports, and in particular, as more ports are uncovered, additional fluid is permitted into the settable device, thereby increasing the force generated. For example, a packer may be set by actuating the locking mechanism via the force generated.

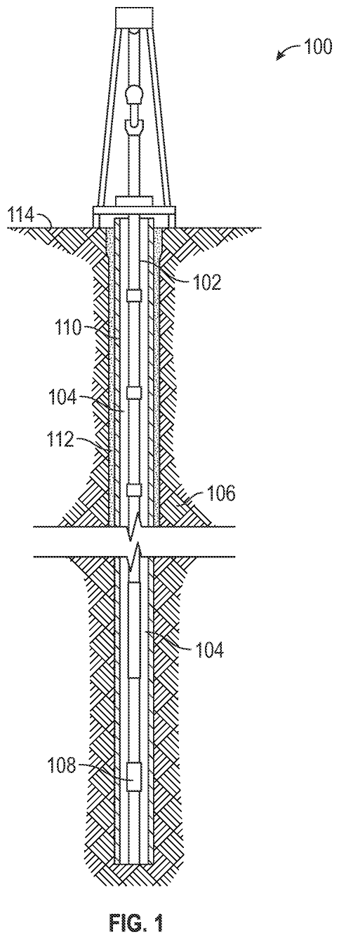

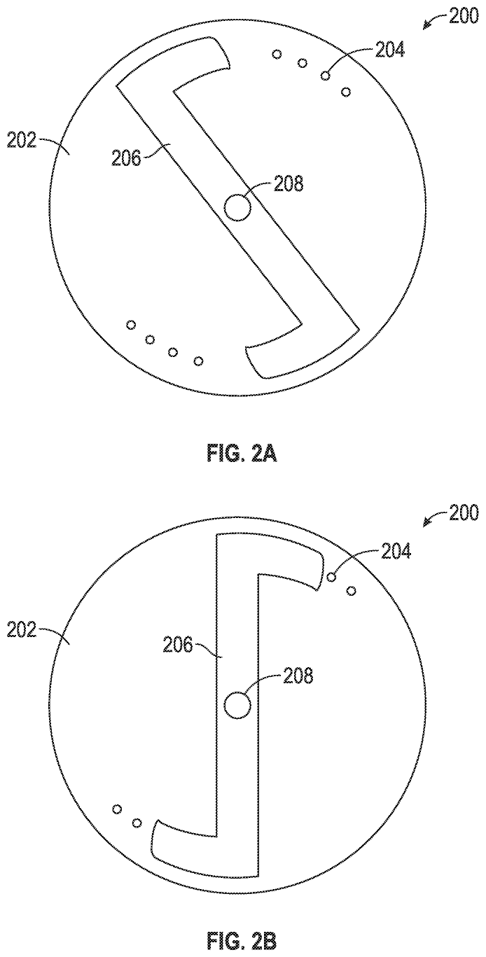

FIG. 1 illustrates a wellbore environment 100 with a downhole tool 108 (for example as shown in FIG. 2A) coupled with a conduit 102, according to the present disclosure. As depicted in FIG. 1, the operating environment 100 includes a wellbore 104 that penetrates a subterranean formation 106. Disposed within the wellbore 104 can be a conduit 102 having one or more downhole tools 108. The wellbore 104 may be drilled into the subterranean formation 106 using any suitable drilling technique. The wellbore 104 may extend substantially vertically away from the earth's surface 114 as shown or in alternative operating environments, portions or substantially all of the wellbore 104 may be vertical, deviated, horizontal, and/or curved. Although the illustrated example shows a production environment, the downhole force setting apparatus may be employed with any suitable downhole conduit 102, including coiled tubing, segmented tubing string, jointed tubing string, wire line, slick line or any other suitable conveyance, or combinations thereof. The conduit 102 extends within the wellbore 104 forming an annular area between the external surface of the conduit 102 and the walls of the wellbore 104 which may have a casing 110 cemented thereon. As shown, the wellbore may be lined with casing 110 that is cemented into place with cement 112. It will be appreciated that although FIG. 1 depicts the wellbore 104 having a casing 110 being cemented into place with cement 112, the wellbore 104 may be wholly or partially cased and wholly or partially cemented, without departing from the scope of the present disclosure.

While the exemplary operating environment depicted in FIG. 1 refers to a wellbore 104 penetrating the earth's surface 114 on dry land, it should be understood that one or more of the methods, systems, and apparatuses illustrated herein may alternatively be employed in other operational environments, such as within an offshore wellbore operational environment for example, a wellbore penetrating subterranean formation beneath a body of water.

FIG. 2A illustrates a schematic view of the downhole force setting apparatus 200 with the plurality of ports 204 all uncovered, according to the present disclosure. The downhole force setting apparatus 200 can include a valve 206 coupled with a valve manifold 202 or valve face. The valve manifold 202 forms a plurality of ports 204 through which fluid can flow. The valve 206 can be, as illustrated in FIG. 2A, a rotary valve which rotates about a point on the valve manifold 202 to expose and/or cover one or more of the plurality of ports 204 formed in the valve manifold 202. In other examples, the valve 206 can be a linear valve which translates linearly. In yet other examples, the valve 206 can be any component which translates to cover and/or expose one or more of the plurality of ports 204 to control the flow of fluid across the valve manifold 202.

The plurality of ports 204 can correspond to a plurality of pistons. The ports 204 are configured to allow fluid to flow into the ports 204 into and through the pistons connected to the ports 204. The valve 206 also includes a low pressure port 208 through which fluid can flow. The low pressure port 208 has a diameter larger than the diameters of the plurality of ports 204. Accordingly, the fluid flowing through the plurality of ports 204 flows with a greater velocity than the fluid flowing through the low pressure port 208.

The valve 206 may be provided in various shapes and sizes. For example, the valve 206 may include an elongated portion 210 which can have ends 212 that extend substantially perpendicularly from the elongated portion 210. The valve 206 may be rotatable to cover one or more ports 204. For example, the valve 206 can have an elongated body with the ends extending to create a “hook” shape and rotatable such that the ends can cover or uncover one or more of the plurality of ports 204. Fluid, such as high pressurized oil, from the tubing or annulus or a fluid reservoir that is a part of the tool itself, may flow from the plurality of pistons and be discharged through the plurality of ports 204 on the valve manifold 202. In some examples, fluid can be restricted by covering one or more ports 204 with the valve 206. An electric motor can rotate the valve 206, which can be biased in one direction. In other examples, the valve 206 can translate or rotate in two or more directions. High pressurized oil flows through the pistons and out of the ports away from the rotary valve 206. As illustrated in FIG. 2A, all of the ports 204 are uncovered by the valve 206, so the fluid only flows through the ports 204 at a high rate to provide a high force.

FIG. 2B illustrates a schematic view of the downhole force setting apparatus 200 with some of the plurality of ports 204 covered by the valve 206. As illustrated, the valve manifold 202 forms the plurality of ports 204, with the plurality of ports 204 each in fluid communication with a piston. The valve manifold 202 forms a plurality of ports 204 which are fluidly connected to a passageway on each end 212 of the valve. For example, the ends 212 of the valve 206 may form the openings to permit the flow of fluids from the pistons and out of the ports 204 into the valve. The passageway is fluidly connected to the low pressure port 208. When one or more of the plurality of ports 204 are covered by the valve 206, the fluid flows from the covered ports 204 through the openings into the passageway of the valve 206. The fluid then flows out of the low pressure port 208. As the low pressure port 208 has a larger diameter than the diameter of the ports 204, the fluid flowing through the low pressure port 208 has a lower velocity, providing a lower force. By covering more or less of the ports 204, the force from the fluid can be variably adjusted by the ratio of fluid flowing through the ports 204 and through the low pressure port 208.

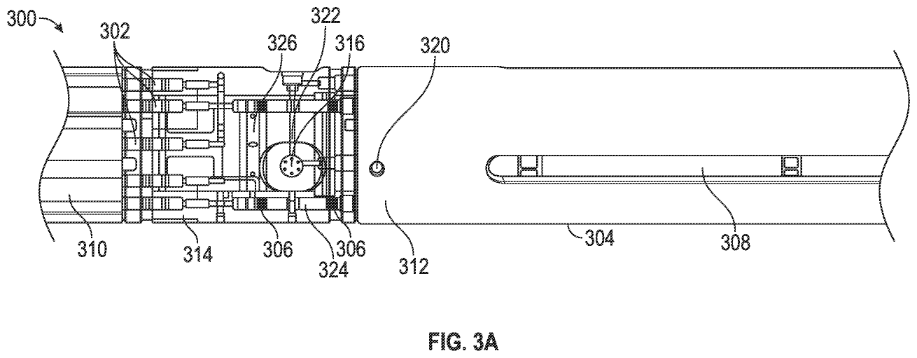

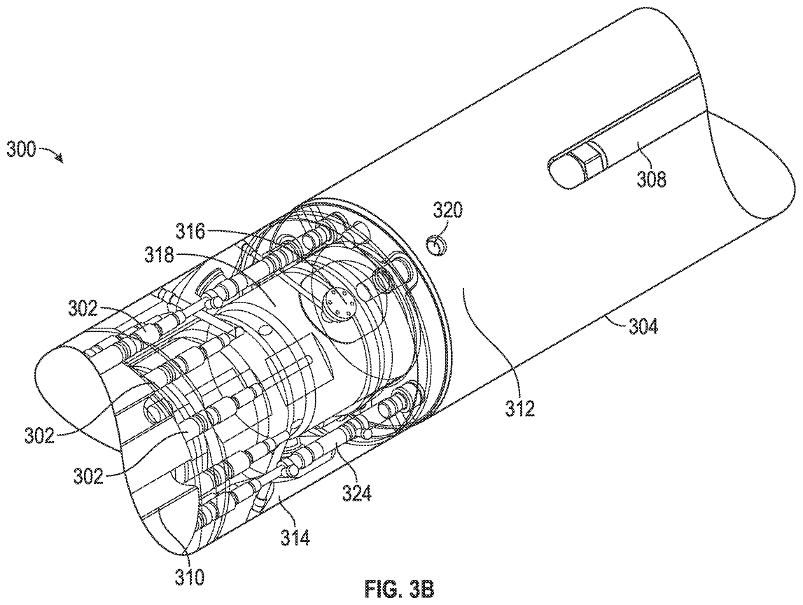

FIG. 3A and FIG. 3B illustrate schematic views of a sampler assembly 300 with a plurality of samplers 302 and a downhole force setting apparatus 200 provided within. As shown, the sampler assembly 300 includes a body 304. The body 304 can include a plurality of segments which can be connected together by threaded connections or any other suitable means. One or more seals 306 can be located adjacent each of the threaded connections. In at least one example, the seals 306 can include o-rings. The body 304 can include a fluid chamber section 308, a sample chamber section 310, a valve housing section 312, and an air chamber section 314. The fluid chamber section 308 is fluidly coupled to the one or more ports of the downhole force setting apparatus 200.

The valve housing section 312 and a mandrel 318 can define an annular region inside the sampler assembly 300 in which one or more samplers 302 may be disposed. The samplers 302 can receive and store fluid for sampling either within the sampling assembly 300 or when retrieved at the surface. The valve housing section 312 of the body 304 can form a sample port 320, which permits fluid communication from outside the sample assembly 300, for example to receive fluid from the well. The fluid can flow from the sample port 320 to one or more of the samplers 302 through pistons 324 and fluid passages 326. In the illustrated example, nine samplers 302 are positioned in the annular region. In some examples, more or less than nine samplers 302 may be implemented.

A rupture disk 316 initially isolates the fluid chamber section 308 from the air chamber 314. The fluid chamber section 308 captures reservoir fluids. In some examples, more than one rupture disk 316 may be used for a discrete triggering event. In some examples, rupture disks 316 may be ruptured when exposed to predetermined forces. When a pressure differential between the outside well zone and the air chamber section 314 reaches a predetermined level, the rupture disk 316 ruptures, thus permitting fluid to flow from the fluid chamber section 308 through the air chamber section 314 into the sample chamber section 310.

According to some examples, the sampler assembly 300 can be disposed in the wellbore, with the samplers 302 closed to prevent fluid from entering the samplers 302. Once the sampler assembly 300 has been deployed to a desired location, an elevated fluid pressure may be applied to the sampler assembly 300 that is above the threshold pressure needed to rupture the rupture disk 316. Once the rupture disk 316 is ruptured, the fluid is communicated to a longitudinal conduit 322, which in turn is communicated through the pistons 324 and fluid passages 326 to the respective samplers 302. The fluid, under elevated annular fluid pressure, when communicated to the samplers 302 actuates a sampler activation mechanism in each of the samplers 302 to open up respective valves corresponding to ports to allow fluid in the carrier inner bore to flow into the samplers 302. Before the rupture disk 316 is ruptured, the longitudinal conduit 322, pistons 324, and fluid passages 326 may be filled with air, aqueous or an oligeanous fluid or any other suitable fluid.

As illustrated in FIGS. 3A and 3B, a plurality of samplers 302 can be actuated by rupturing the rupturing disk 316, which is used to provide selective communication between fluid passages 326 and each of the samplers 302. Thus, a plurality of the samplers 302 can simultaneously receive fluid samples therein from the fluid passage 326. In a similar manner, when rupture disk 316 is ruptured, one or more additional samplers 302 can receive fluid samples therein, and when the rupture disk 316 is ruptured a further group of multiple samplers 302 will receive fluid samples therein. Rupture disks 316 may be selected so that they are ruptured sequentially when different forces are enacted thereon or they may be selected so that they are ruptured simultaneously, when under the same force.

For example, the valve 206 on the downhole force setting apparatus 200 is actuatable to open the ports 320 to enable fluids to flow into the samplers 302. The downhole force setting apparatus 200 is adjustable to generate different forces as discussed above to rupture disks 316 in the sampler assembly 300. For example, as the valve 206 uncovers more ports 204, the fluid flows at a greater velocity and generates a greater force which can cause the rupture disk 316 coinciding with a set of samplers 302 to rupture and cause fluid to flow into those samplers 302. The valve 206 can cover and/or uncover a predetermined number of ports 204 to control the fluid to flow at a predetermined velocity and generates a predetermined force to rupture a predetermined rupture disk 316 coinciding with a desired set of samplers 302. In at least one example, each individual port 204 on the downhole force setting apparatus 200 can be connected to a different rupture disk 316 (i.e., set of samplers). Once ruptured, fluid flows through the longitudinal conduit 322 and the pistons 324 shift, allowing the fluid to flow through the fluid passage 326 and into the samplers 302.

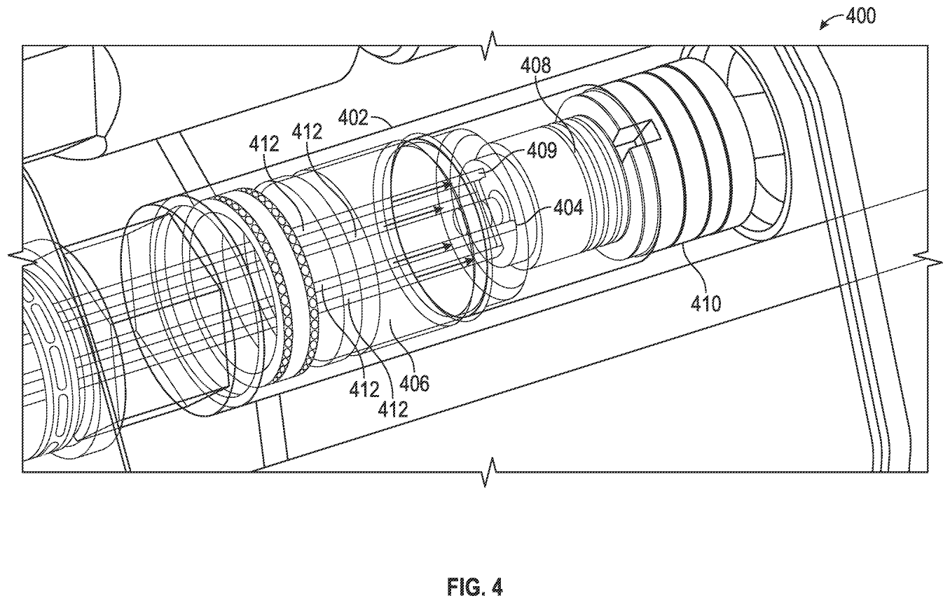

FIG. 4 illustrates a schematic view of a packer assembly 400 which is actuated by a downhole force setting apparatus 200. The packer 400 is first deployed in a wellbore and is unset. The packer 400 may be an annulus packer, a tubing packer, a retrievable packer, a non-retrievable packer, a multiset packer, or any other suitable packer. As depicted in FIG. 4, the packer assembly 400 includes a central mandrel 402 having an upper threaded end which allows the packer assembly 400 to be coupled with a conduit 102 (for example, shown in FIG. 1). The central mandrel 402 defines an internal bore 406 which extends longitudinally along the central mandrel 402. A plurality of fixed actuating pistons 412 fluidly connected to radial fluid communication ports 404 are disposed in the central mandrel 402 to provide fluid communication between the internal bore 406 of the central mandrel 402 and its radial exterior 410. While four pistons 412 are illustrated in FIG. 4, one, two, three, or more than four pistons 412 can also be implemented without deviating from the scope of the disclosure. Sealing between each piston 412 and the central mandrel 402 can be achieved, for example by a respective sealing element, such as an O-ring, and a respective pair of back-up rings. The plurality of actuating pistons 412 can have multiple diameters separated by a sealing element, such as an O-ring seal.

Fluid flow through the fluid ports 404 is initially blocked by the presence of the downhole force setting apparatus 200. The actuating pistons 412 move a locking mechanism out of the way so that packer 400 can be set and can move locking mechanism back so the packer 400 is unset. The locking mechanism is includes the valve 206 and the actuating sleeve 414. The downhole force setting apparatus 200 can provide a predetermined force, as discussed above, to the packer elements by rotating or selectively covering and uncovering the ports 404. The valve 206 on the downhole force setting apparatus 200 in a closed configuration blocks the fluid ports 404, such that fluid is provided to the packer elements such that the packer 400 is unset. Selectively setting and unsetting the packer can be done with a pressure sensor on a controller to sense a pressure pulse in order to activate the packer 400. In some examples, this can be done by an automatic setting. For example, when the pressure is a particular predetermined pressure downhole, such as about 500 psi, a certain number of ports 204 are exposed on the apparatus 200 to activate the packer 400. When the packer 400 is at low hydrostatic pressure, enough force can be generated to compress the packer 400 and then swell it out against the walls of the wellbore. This is done by exposing a greater number of ports 204 to increase the force from the fluid flowing across the downhole force setting apparatus 200. In other examples, more ports 204 can be covered such that more fluid flows through the low pressure port 208 and less fluid flows through the ports 204, and the force from the fluid flowing across the downhole force setting apparatus 200 can be decreased to the desired level. Accordingly, the downhole force setting apparatus 200 can adjust the amount of force from the fluid flowing therethrough to any desired level of a plurality of levels. The pressurized fluid then adds pressure to the pistons 412 to actuate the pistons 412. A hydraulic line can lead to the actuating pistons 412, which can convey hydraulic fluid to the packer 400 to expand the packer 400.

In some examples, the hydrostatically operated downhole force setting apparatus 200 can be adjusted to permit fluid to flow at a greater velocity from one portion of the downhole force setting apparatus 200 and a lower velocity on an opposing side of the downhole force setting apparatus 200. The hydrostatic pressure from the fluid applies a force to the sealing element to move it to its expanded position. The actuating pistons 412 can be mounted between the sealing element and mandrel 402. A locking mechanism can be used for the actuating mechanism, where the locking mechanism is responsive to a predetermined force. For example, force from fluid under wellbore hydrostatic pressure can bear upon the pressure receiving area 408 of the actuating pistons 412 and urge the pistons 412 to move axially upwardly. A downhole force setting apparatus 200 can compress the packer 400 axially to cause it to expand radially and become set.

In some examples, an actuating sleeve 414 also surrounds the central mandrel 402 below the ring. The actuating sleeve 414 can set the packer element that is correspondingly positioned on the radial exterior of the central mandrel 402. During setting of the packer assembly 400, the actuating sleeve 414 may remain stationary with respect to the central mandrel 402. The downhole force setting apparatus 200 can move the actuating sleeve axially. This movement of the actuating sleeve 414 can shear screws and permit fluid to flow through the fluid communication ports 404, which unlocks the actuating pistons 412 from engagement with the central mandrel 402. As movement of the actuating sleeve 414 unblocks the fluid ports 404, hydrostatic fluid pressure present within the wellbore 104 is then transmitted through the ports 404 and enters the pressure receiving area 408.

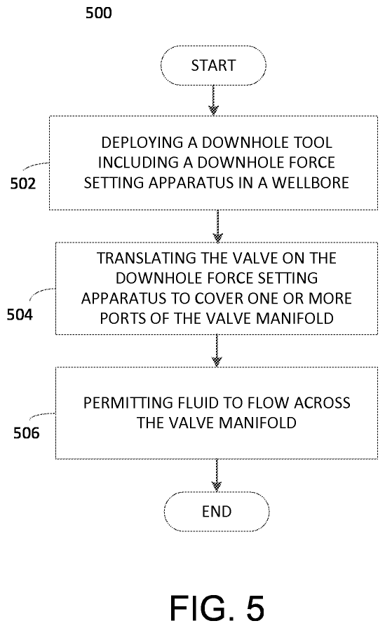

Referring to FIG. 5, a flowchart is presented in accordance with an example embodiment. The method 500 is provided by way of example, as there are a variety of ways to carry out the method. The method 500 described below can be carried out using the configurations illustrated in FIGS. 2A-2B, for example, and various elements of these figures are referenced in explaining example method 500. Each block shown in FIG. 5 represents one or more processes, methods or subroutines, carried out in the example method 500. Furthermore, the illustrated order of blocks is illustrative only and the order of the blocks can change according to the present disclosure. Additional blocks may be added or fewer blocks may be utilized, without departing from this disclosure. The example method 500 can begin at block 502.

At block 502, the downhole force setting apparatus 200 is deployed with a downhole tool in a wellbore. The downhole force setting apparatus 200 can be deployed within a sampler assembly 300 or a packer assembly 400. The downhole force setting apparatus 200 is used to apply a more accurate force to the elements of the downhole tool that is deployed within. The force applied to the elements of the downhole hole depends on the hydrostatic changes from well to well or changes in hydrostatic pressure from within the same well.

At block 504, the valve is translated to cover one or more ports of the valve manifold. The translation depends on the pressure downhole which is communicated using an acoustic system or pressure profile. The pressure downhole can be sensed by a pressure sensor on a controller. For example, a pressure pulse is sent up and a measurement of the annulus pressure is sent up, which is then used to determine how to control the valve. The pressure can also be pre-programmable and set up automatically.

At block 506, fluid is permitted to flow across the valve manifold. High pressurized fluid is transmitted through the valve and surrounds the valve when the ports are covered. The more pistons that are covered the less force is applied. If all ports are covered by the valve, then no force is generated. The force can be adjusted in as many increments as there are ports on the valve manifold. The ports can go to a single staged piston or multiple pistons to function a downhole tool.

### Claim Bank to be Added

While the foregoing is directed to embodiments of the present disclosure, other and further embodiments of the disclosure may be devised without departing from the basic scope thereof, and the scope thereof is determined by the claims that follow. Those skilled in the art, having the benefit of this disclosure, will appreciate numerous modifications and variations therefrom. It is intended that the appended claims cover all such modifications and variations as fall within the true spirit and scope of this present disclosure.

What is claimed is:

1. A downhole force setting apparatus comprising:
a valve manifold having a plurality of ports; and
a valve coupled to the valve manifold, the valve being actuatable to selectively cover or uncover one or more of the plurality of ports, the valve having a plurality of openings which are in fluidic communication with the covered plurality of ports, the openings being in fluid communication with a low pressure port.

2. The downhole force setting apparatus of claim 1, wherein the valve is rotatable to cover one or more of the plurality of ports.

3. The downhole force setting apparatus of claim 2, wherein the plurality of ports are in fluid communication with a plurality of pistons.

4. The downhole force setting apparatus of claim 3, wherein when a number of the plurality of ports that are uncovered increases, a downhole force enacted on the pistons increases.

5. The downhole force setting apparatus of claim 1, wherein the valve is translatable to uncover one or more of the plurality of ports.

6. The downhole force setting apparatus of claim 1, wherein the plurality of ports permit fluid to flow across the valve manifold.

7. The downhole force setting apparatus of claim 1, wherein the plurality of ports are used to port fluid from a fluid reservoir.

8. The downhole force setting apparatus of claim 1, wherein when all of the plurality of ports are covered by the valve, all fluid flowing across the valve manifold flows through the low pressure port.

9. A method for adjusting downhole force comprising:
deploying a downhole tool in a wellbore, the downhole tool including a downhole force setting apparatus, the downhole force setting apparatus including:
a valve manifold forming a plurality of ports, and
a valve coupled to the valve manifold, the valve being actuatable to selectively cover or uncover one or more of the plurality of ports, the valve having a plurality of openings which are in fluidic communication with the covered plurality of ports, the openings being in fluid communication with a low pressure port, wherein a diameter of the low pressure port is larger than a diameter of each of the plurality of ports;
translating the valve to cover one or more ports of the valve manifold; and
permitting fluid to flow across the valve manifold.

10. The method of claim 9, wherein the valve is translatable to uncover one or more of the plurality of ports.

11. The method of claim 9, wherein the plurality of ports permit fluid to flow across the valve manifold.

12. The method of claim 9, wherein the plurality of ports are used to port fluid from a wellbore.

13. A system comprising:
a drill string disposed into a wellbore;
one or more downhole tools coupled to the drill string; and
a downhole force setting apparatus positioned within the one or more downhole tools comprising:
a valve manifold forming a plurality of ports, and
a valve coupled to the valve manifold, the valve being actuatable to selectively cover or uncover one or more of the plurality of ports, the valve having a plurality of openings which are in fluidic communication with the covered plurality of ports, the openings being in fluid communication with a low pressure port, wherein a diameter of the low pressure port is larger than a diameter of each of the plurality of ports.

14. The system of claim 13, wherein the valve is rotatable to cover one or more of the plurality of ports.

15. The system of claim 14, wherein the plurality of ports are in fluid communication with a plurality of pistons.

16. The system of claim 15, wherein when a number of the plurality of ports that are uncovered increases, a downhole force enacted on the pistons increases.

17. The system of claim 13, wherein the valve is translatable to uncover one or more of the plurality of ports.

18. The system of claim 13, wherein the plurality of ports permit fluid to flow across the valve manifold.

19. The system of claim 13, wherein the plurality of ports are used to port fluid from a wellbore.

20. The system of claim 13, wherein when all of the plurality of ports are covered by the valve, all fluid flowing across the valve manifold flows through the low pressure port.
